(19) United States
(12) Patent Application Publication
(10) Pub. No.: US 2026/0010155 A1
(43) Pub. Date: Jan. 8, 2026

(54) INTEGRATED ASSET MODEL WITH REAL TIME MONITORING OF CARBON CAPTURE, UTILIZATION, AND STORAGE VALUE CHAIN

(71) Applicant: NUOVO PIGNONE TECNOLOGIE - S.R.L., Florence (IT)

(72) Inventors: Prem Saini, Voorburg (NL); Karan Sonawane, Maharashtra (IN); Akshay Mehta, Mumbai (IN); James Brady, Houston, TX (US); Awes Ahmed Khan, Houston, TX (US)

(21) Appl. No.: 18/882,216

(22) Filed: Sep. 11, 2024

Related U.S. Application Data
(60) Provisional application No. 63/666,760, filed on Jul. 2, 2024.

(51) Int. Cl. G05B 23/02

(52) U.S. Cl. CPC G05B 23/0275; G05B 23/0243; G05B 23/027

(57) ABSTRACT

A computer-implemented method includes: generating, by a computing device, a digital representation of a value chain including a set of interconnected assets; processing, by the computing device, an alert associated with the set of interconnected assets; determining, based on processing the alert: a risk associated with the value chain; and a root cause associated with the risk, wherein the root cause is associated with a first asset included in the set of interconnected assets; and providing a warning signal to a second asset included in the set of interconnected assets, wherein the second asset is upstream or downstream of the first asset.

### CROSS REFERENCE TO RELATED APPLICATIONS

This application claims the benefit of an earlier filing date from U.S. Provisional Application Ser. No. 63/666,760 filed Jul. 2, 2024, the entire disclosure of which is incorporated herein by reference.

### BACKGROUND

In the resource recovery and fluid sequestration industries, some monitoring techniques provide only isolated monitoring for an individual section of an entire carbon capture, utilization, and sequestration (CCUS) value chain. Accordingly, for example, if a problem exists in the CCUS value chain, the isolated monitoring is unable to support effective identification of the root cause of the problem. For example, existing approaches are unable to identify whether the root cause lies within the system or is propagated from a connected system,

### SUMMARY

Embodiments of the present disclosure are directed to a computer-implemented method including: generating, by a computing device, a digital representation of a value chain including a set of interconnected assets; processing, by the computing device, an alert associated with the set of interconnected assets; determining, based on processing the alert: a risk associated with the value chain; and a root cause associated with the risk, wherein the root cause is associated with a first asset included in the set of interconnected assets; and providing a warning signal to a second asset included in the set of interconnected assets, wherein the second asset is upstream or downstream of the first asset.

Embodiments of the present disclosure are directed to a system including: a value chain including a set of interconnected assets; and a computing device including a processor and a memory, wherein the memory includes instructions stored thereon that, when executed by the processor, cause the processor to perform operations including: generating a digital representation of the value chain including the set of interconnected assets; processing an alert associated with the set of interconnected assets; determining, based on processing the alert: a risk associated with the value chain; and a root cause associated with the risk, wherein the root cause is associated with a first asset included in the set of interconnected assets; and providing a warning signal to a second asset included in the set of interconnected assets, wherein the second asset is upstream or downstream of the first asset.

Embodiments of the present disclosure are directed to a computer program product including a computer readable storage medium having program instructions embodied therewith, the program instructions executable by a processor to cause the processor to perform operations including: generating a digital representation of a value chain including a set of interconnected assets; processing an alert associated with the set of interconnected assets; determining, based on processing the alert: a risk associated with the value chain; and a root cause associated with the risk, wherein the root cause is associated with a first asset included in the set of interconnected assets; and providing a warning signal to a second asset included in the set of interconnected assets, wherein the second asset is upstream or downstream of the first asset.

Further aspects supported by the present disclosure and features of example embodiments are illustrated in the accompanying drawings and/or described in the following description.

### BRIEF DESCRIPTION OF THE DRAWINGS

The following descriptions should not be considered limiting in any way. With reference to the accompanying drawings, like elements are numbered alike:

FIG. 1A illustrates a system supportive of real time monitoring of a CCUS value chain in accordance with aspects of the present disclosure,

FIG. 1B illustrates an example of a digital representation generated and provided by a system in accordance with one or more embodiments of the present disclosure.

FIG. 2 depicts a block diagram of a processing system in accordance with one or more embodiments of the present disclosure.

FIG. 3 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

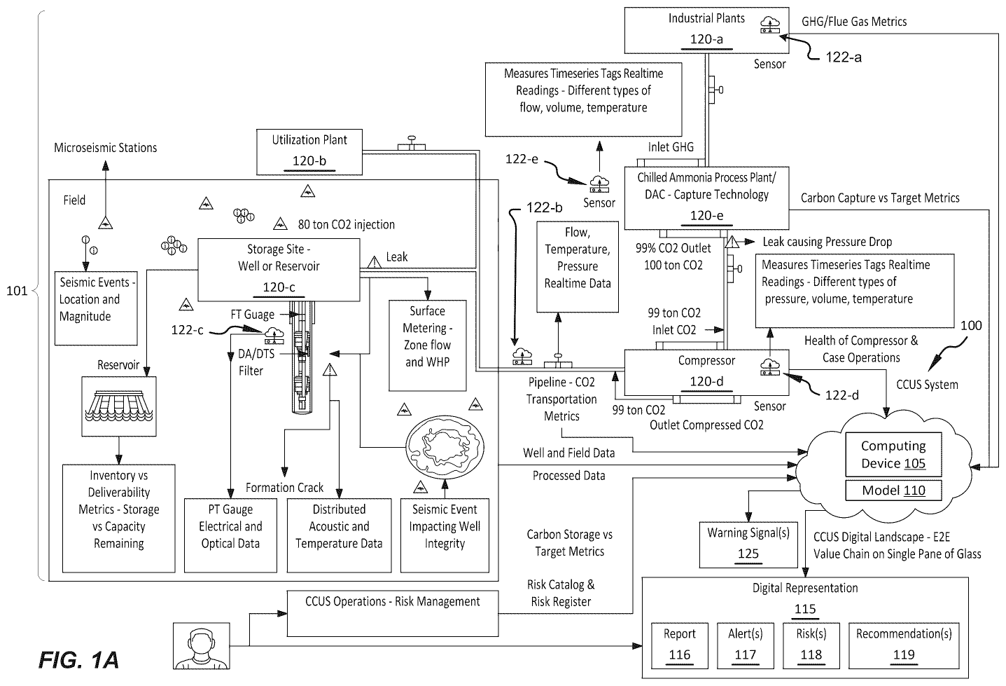

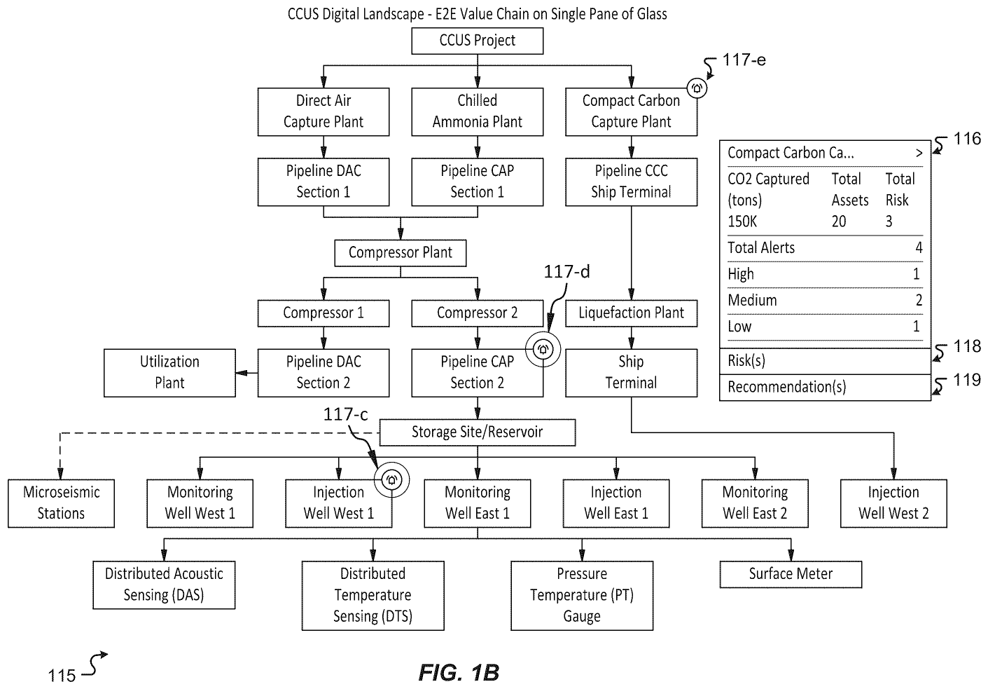

FIG. 1A illustrates a system 100 supportive of real time monitoring of a CCUS value chain 101 in accordance with aspects of the present disclosure. The system 100 provides an integrated asset model 110 supportive of the real time monitoring of the CCUS value chain 101.

In an example, the system 100 and integrated asset model 110 may be implemented in a cloud network to which components of the CCUS value chain 101 are connected. In some aspects, the integrated asset model 110 may be implemented at a computing device 105 (or multiple computing devices 105) included in the cloud network.

As will be described herein, the system 100 is capable of generating and providing a digital representation 115 of a CCUS value chain 101 with connected assets 120 included in the CCUS value chain 101. The digital representation 115 may be referred to herein as a digital landscape or digital twin of the CCUS value chain 101. Further, embodiments of the present disclosure are not limited thereto a CCUS value chain 101 and the systems and techniques described herein may support generating and providing a digital representation 115 of any suitable end-to-end physical system including multiple connected assets 120.

In the example illustrated at FIG. 1A, the connected assets 120 may include asset 120-a (e.g., an industrial plant), asset 120-b (e.g., a utilization plant), asset 120-c (e.g., a storage site (well or reservoir)) (also referred to herein as a sequestration site), asset 120-d (e.g., a compressor), and asset 120-e (e.g., a processing plant, for example, a chilled ammonia process plant/DAC).

The system 100 may include sensors 122 respectively associated with measuring performance of the connected assets 120. The sensors 122 may provide measured data in real-time or based on other criteria (e.g., a temporal period, a trigger condition, or the like). In some aspects, the sensors 122 may provide metrics associated with a performance parameter between different connected assets 120.

For example, sensor 122-a may provide GHG/flue gas metrics associated with asset 120-a.

In another example, sensor 122-b may provide pipeline metrics (e.g., CO2 transportation metric). For example, sensor 122-b may provide flow, temperature, and pressure data regarding the flow of CO2 between different connected assets 120 (e.g., between asset 120-b, asset 120-c, and/or asset 120-d). Accordingly, for example, sensor 122-b may provide metrics associated with transporting a product (e.g., CO2) associated with the CCUS value chain 101 between different connected assets 120.

Similarly, for example, the system 100 may include other sensors 122-b (not illustrated) capable of providing pipeline metrics (e.g., flow, temperature, and pressure data) regarding the flow of CO2 between other connected assets 120 (e.g., between asset 120-d and asset 120-e, between asset 120-a and asset 120-e, and the like).

In another example, sensors 122-c associated with the asset 120-c may provide sensor data associated with a well site. For example, sensors 122-c may respectively provide pressure and temperature (PT) gauge electrical and optical data, distributed acoustic and temperature data, and surface metering data (e.g., associated with zone flow and wellhead protection (WHP)) associated with the well site.

In another example, sensor 122-d may provide metrics related to the health of the asset 120-d and case operations. For example, sensor 122-d may provide pressure, volume, and temperature measurements associated with the asset 120-d. In an example, the sensor 122-d may measure timeseries tags real-time readings. The real-time readings may include different types of flow, volume, and temperature.

In another example, sensor 122-e may provide data related to actual carbon capture by the asset 120-e versus target metrics, For example, sensor 122-e may provide pressure, volume, and temperature measurements associated with the asset 120-e. In an example, the sensor 122-e may measure timeseries tags real-time readings. The real-time readings may include different types of flow, volume, and temperature.

Embodiments of the present disclosure are not limited to the example assets 120, sensors 122, and measurements described with reference to FIG. 1A. For example, the CCUS value chain 101 may include more than 100,000 assets 120 of various asset types, and the system 100 is capable of performing monitoring and root cause identification of the CCUS value chain 101 as described herein (e.g., acquiring and processing data associated with the connected assets 120), in real-time, In an example, at the cloud level, the system 100 is capable of acquiring or sampling the data from computing devices (e.g., edge computing devices (not illustrated)) respectively associated with the connected assets 120, sensors 122 respectively associated with the connected assets 120, and other sensors 122 associated with the CCUS value chain 101.

The system 100 provides real-time monitoring of a full value chain from capture to sequestration. For example, the system 100 supports real-time monitoring of CO2 flow throughout the entire CCUS value chain 101 from capture to sequestration, with all connected assets 120 throughout the entire CCUS value chain 101.

The system 100 provides automatic identification of alerts, alert locations, risks, and risk locations in the CCUS value chain 101. For example, the system 100 is capable of intelligently identifying alerts that lie within the CCUS value chain 101 based on real-time data monitoring of individual assets 120 connected through the system 100.

In some aspects, the system 100 may autonomously generate a warning signal 121 along with recommendations 119, if any, to any upstream or downstream connected assets 120 included in the CCUS value chain 101. In some examples, the recommendations 119 may include corrective actions the system 100 has determined may (if implemented) eliminate a risk 118 identified by the system 100, mitigate or reduce the impact of the risk 118, prevent future occurrences of the risk 118, and the like. In some examples, the recommendations 119 may indicate a respective asset 120 (or assets 120) associated with the identified risk 118.

In some aspects, the system 100 may include any of a report 116, an identified risk 118, a recommendation 119, and a warning signal 121 described herein in the digital representation 115. Additionally, or alternatively, the system 100 provide any of a report 116, an identified risk 118, a recommendation 119, and a warning signal 121 separately from the digital representation 115.

The system 100 connects individual assets 120 through the value chain 101 and is capable of identifying a root cause (or a combination of causes) that lies within the CCUS value chain 101 or is propagated among connected assets 120.

The system 100 may provide real-time assessment of risk and the impact of the risk propagating from one system (e.g., one connected asset 120) to another.

Although the example with reference to FIG. 1A is described with respect to a CCUS value chain 101, embodiments of the present disclosure are not limited thereto. The system 100 is capable of providing real-time monitoring and root cause identification for any value chain including interconnected assets 120.

Compared to some other approaches, aspects of the system 100 and techniques described herein provide advantages such as, for example, real-time notification (e.g., via alerts 117) of issues to end users, and a digital view (e.g., digital representation 115) of capture, transportation, and storage. Aspects of the system 100 and techniques described herein provide advantages such as, for example, early identification/warning for risk impact on the health of a connected asset 120 via, for example, warning signals 125 described herein. Aspects of the system 100 and techniques described herein provide advantages such as, for example, CO2 flow metrics from capture to storage based on which the system 100 (with or without input from a user) may identify leakages/anomalies in any step of the CCUS value chain 101. Aspects of the system 100 and techniques described herein provide advantages such as, for example, visualization (e.g., via digital representation 115, alerts 117, and recommendations 119 described herein) of real-time asset failure notifications and the impact of asset failures on the CO2 flow.

The real-time assessment of risk as supported by the system 100 described herein is lacking in other approaches which are based on isolated monitoring of individual systems. Other approaches fail and are unable to provide a real-time digital value chain representation of the CO2 flow from capturing to sequestration with all connected assets 120 throughout the entire CCUS value chain 101.

FIG. 1B illustrates an example of the digital representation 115 of FIG. 1A generated and provided by the system 100 in accordance with one or more embodiments of the present disclosure.

Via the digital representation 115, the system 100 provides a digital landscape representative of the CCUS value chain 101. For example, the digital representation 115 provides a visualization of an end-to-end digital landscape of the CCUS value chain 101 and the included connected assets 120. The system 100 may display the digital representation 115 via a user interface.

In an example, the digital representation 115 may include a representation of connected assets 120 (e.g., a direct air capture plant, a chilled ammonia plant, a compact carbon capture plant, a compressor plant, a utilization plant, a storage site/reservoir, a liquification plant, and the like) described herein.

In an example described with reference to FIGS. 1A and 1B, the digital representation 115 may include a report 116 (reporting data) generated by the system 100. The report 116 may be associated with the CCUS value chain 101. For example, the report 116 may include performance data (e.g., CO2 captured), total quantity of connected assets 120 (e.g., 20 assets), and total quantity of risks 118 determined by the system 100 (e.g., 3 risks).

In the example, the report 116 may indicate a total quantity of alerts 117 (e.g., 4 alerts, including 1 high, 2 medium, and 1 low alert) associated with the CCUS value chain 101. In some aspects, the system 100 may indicate, via the digital representation 115, locations of the alerts 117 within the CCUS value chain 101.

In an example described with reference to FIGS. 1A and 1B, the system 100 indicates that there is an alert 117-e associated with the sensor 122-e (Compact Carbon Capture Plant), and the alert 117-e may indicate a performance metric which fails to meet a target metric. In the example, the system 100 indicates an alert 117-d associated with asset 120-d (compressor) and Pipeline CAP section 2, and the alert 117-d may indicate the presence of a leak causing a pressure drop. In the example, the system 100 indicates an alert 117-c associated with asset 120-c (storage site) and Injection Well West 1, and the alert 117-c may indicate the presence of a formation crack related to a seismic event. In some aspects, the system 100 may provide, in the alert 117-c, an impact of the formation crack with respect to well integrity. Accordingly, for example, the system 100 may indicate a risk 118 (or risks 118) which the system 100 has determined based on the alerts 117 in association with the CCUS value chain 101.

In some embodiments, the system 100 may generate and provide a recommendation 119 associated with addressing the risk 118. For example, the recommendation 119 may include one or more corrective actions which the system 100 has determined may (if implemented) eliminate the risk 118, mitigate or reduce the impact of the risk 118, prevent future occurrences of the risk 118, and the like. In some aspects, the corrective actions may be associated with connected assets 120 and related components associated with the alerts 117.

Additionally, or alternatively, the corrective actions may be associated with other components which the system 100 has determined as a root cause (or one of a combination of causes) associated with the alerts 117 and associated risk 118. For example, although the system 100 may identify alerts 117 associated with asset 120-c through asset 120-e and/or components thereof, the system 100 may identify that an issue related to performance (e.g., based on sensor data) associated with another connected asset 120 included in the CCUS value chain 101 is the root cause (or one of a combination of causes) resulting in the alerts 117.

Accordingly, for example, embodiments of the present disclosure provide a system 100 capable of conducting a holistic assessment of CCU value chains to optimize and develop technically and economically feasible CCU value chains, in which the system 100 includes a framework for CCUS supply chain risk management to address potential accidents, leaks, or failures at different stages of CCUS operations with dynamic visualization capabilities. The system 100 provides a digital representation 115 with real-time monitoring and analysis of an entire CCUS value chain 101, connecting individual assets 120 to identify alerts 117, conduct root cause analysis, issue warning signals 125 with recommendations 119, and assess risk impact. The system 100 provides end-to-end optimization from carbon capture through into injection into a well head.

The digital representation 115 generated by the system 100 is a real-time digital twin of the CCUS value chain 101 and included assets. The system 100 may generate the digital representation 115 using various integrated asset models 110. In some aspects, the integrated asset models 110 may include physics-based models which support a comprehensive monitoring and alert solution for real-time monitoring and root cause identification as described herein. In some examples, the system 100 may provide local and remote visualization tools for users to view real-time operational updates (e.g., based on sensor data provided by sensors 122) associated with the CCUS value chain 101.

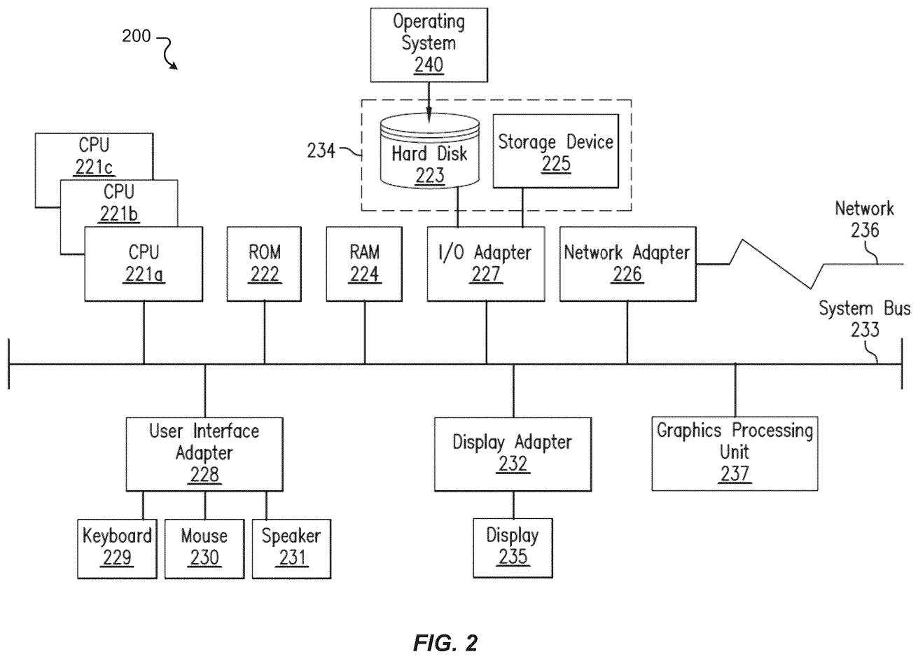

It is understood that embodiments of the present disclosure are capable of being implemented in conjunction with any suitable type of computing environment now known or later developed. For example, FIG. 2 depicts a block diagram of a processing system 200, which can be used for implementing the techniques described herein. For example, aspects described herein of the system 100 of FIG. 1A may be implemented by the processing system 200.

In examples, processing system 200 has one or more central processing units (processors) 221a, 221b, 221c, etc. (collectively or generically referred to as processor(s) 221 and/or as processing device(s)). In aspects of the present disclosure, each processor 221 can include a reduced instruction set computer (RISC) microprocessor. Processors 221 are coupled to system memory (e.g., random access memory (RAM) 224) and various other components via a system bus 233. Read only memory (ROM) 222 is coupled to system bus 33 and can include a basic input/output system (BIOS), which controls certain basic functions of processing system 200.

Further illustrated are an input/output (I/O) adapter 227 and a communications adapter 226 coupled to system bus 233. I/O adapter 227 can be a small computer system interface (SCSI) adapter that communicates with a hard disk 223 and/or a tape storage drive 225 or any other similar component. I/O adapter 227, hard disk 223, and tape storage drive 225 are collectively referred to herein as mass storage 234. Operating system 240 for execution on processing system 200 can be stored in mass storage 234. A network adapter 226 interconnects system bus 233 with an outside network 236 enabling processing system 200 to communicate with other such systems.

A display (e.g., a display monitor) 235 is connected to system bus 233 by display adaptor 232, which can include a graphics adapter to improve the performance of graphics intensive applications and a video controller. In one aspect of the present disclosure, adapters 226, 227, and/or 232 can be connected to one or more I/O busses that are connected to system bus 233 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 233 via user interface adapter 228 and display adapter 232. A keyboard 229, mouse 230, and speaker 231 can be interconnected to system bus 233 via user interface adapter 228, which can include, for example, a Super I/O chip integrating multiple device adapters into a single integrated circuit.

In some aspects of the present disclosure, processing system 200 includes a graphics processing unit 237. Graphics processing unit 237 is a specialized electronic circuit designed to manipulate and alter memory to accelerate the creation of images in a frame buffer intended for output to a display. In general, graphics processing unit 237 is very efficient at manipulating computer graphics and image processing and has a highly parallel structure that makes it more effective than general-purpose CPUs for algorithms where processing of large blocks of data is done in parallel.

Thus, as configured herein, processing system 200 includes processing capability in the form of processors 221, storage capability including system memory (e.g., RAM 224), and mass storage 234, input means such as keyboard 229 and mouse 230, and output capability including speaker 231 and display 235. In some aspects of the present disclosure, a portion of system memory (e.g., RAM 224) and mass storage 234 collectively store an operating system 240 to coordinate the functions of the various components shown in processing system 200.

Embodiments of the present disclosure support computer implemented methods of real-time monitoring and root cause identification performed by the system 100 and processing system 200 described herein. In some aspects, the methods may be implemented by an integrated asset model supportive of real time monitoring of a CCUS value chain as described herein.

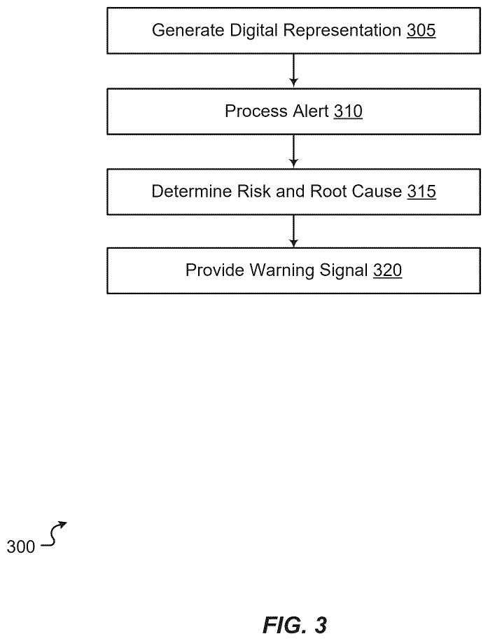

FIG. 3 illustrates an example flowchart of a method 300 in accordance with one or more embodiments of the present disclosure. The method 300 is an example computer-implemented method that may be implemented by the example aspects of a system (e.g., system 100, processing system 200) or computing device (e.g., processor 221) as described herein.

At 305, the method 300 may include generating, by a computing device, a digital representation of a value chain including a set of interconnected assets.

In some aspects, the value chain may include a carbon capture, utilization, and sequestration (CCUS) value chain.

In some aspects, the method 300 may include generating the digital representation using physics-based modeling of the value chain and the set of interconnected assets, where the digital representation is a digital twin of the value chain and the set of interconnected assets.

At 310, the method 300 may include processing, by the computing device, an alert associated with the set of interconnected assets.

At 315, the method 300 may include determining, based on processing the alert: a risk associated with the value chain; and a root cause associated with the risk, where the root cause is associated with a first asset included in the set of interconnected assets.

At 320, the method 300 may include providing a warning signal to a second asset included in the set of interconnected assets, where the second asset is upstream or downstream of the first asset.

In some aspects, the method 300 may include providing, by the computing device, a recommendation including a corrective action associated with the root cause and the first asset.

In some aspects, the method 300 may include processing, by the computing device, a second alert associated with the set of interconnected assets, where the alert and the second alert are respectively associated with different assets included in the set of interconnected assets, where determining the risk and the root cause is further based on processing the second alert.

In some aspects, the method 300 may include processing, by the computing device, sensor data associated with an asset included in the set of interconnected assets, where determining the risk and the root cause is further based on processing the sensor data.

In some aspects, the method 300 may include processing, by the computing device, metrics associated with transporting a product associated with the value chain between different assets included in the set of interconnected assets, where determining the risk and the root cause is further based on processing the metrics.

In some aspects, generating the digital representation, processing the alert, determining the risk and the root cause, and providing the warning signal may be in real-time.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Set forth below are some embodiments of the foregoing disclosure:

Embodiment 1. A computer-implemented method comprising: generating, by a computing device, a digital representation of a value chain comprising a set of interconnected assets; processing, by the computing device, an alert associated with the set of interconnected assets; determining, based on processing the alert: a risk associated with the value chain; and a root cause associated with the risk, wherein the root cause is associated with a first asset comprised in the set of interconnected assets; and providing a warning signal to a second asset comprised in the set of interconnected assets, wherein the second asset is upstream or downstream of the first asset.

Embodiment 2. The computer-implemented method as in any prior embodiment, further comprising: providing, by the computing device, a recommendation comprising a corrective action associated with the root cause and the first asset.

Embodiment 3. The computer-implemented method as in any prior embodiment, further comprising: processing, by the computing device, a second alert associated with the set of interconnected assets, wherein the alert and the second alert are respectively associated with different assets comprised in the set of interconnected assets, wherein determining the risk and the root cause is further based on processing the second alert.

Embodiment 4. The computer-implemented method as in any prior embodiment, further comprising: processing, by the computing device, sensor data associated with an asset comprised in the set of interconnected assets, wherein determining the risk and the root cause is further based on processing the sensor data.

Embodiment 5. The computer-implemented method as in any prior embodiment, further comprising: processing, by the computing device, metrics associated with transporting a product associated with the value chain between different assets comprised in the set of interconnected assets, wherein determining the risk and the root cause is further based on processing the metrics.

Embodiment 6. The computer-implemented method as in any prior embodiment, wherein the value chain comprises a carbon capture, utilization, and sequestration (CCUS) value chain.

Embodiment 7. The computer-implemented method as in any prior embodiment, further comprising: generating the digital representation using physics-based modeling of the value chain and the set of interconnected assets, wherein the digital representation is a digital twin of the value chain and the set of interconnected assets.

Embodiment 8. The computer-implemented method as in any prior embodiment, wherein generating the digital representation, processing the alert, determining the risk and the root cause, and providing the warning signal are in real-time.

Embodiment 9. A system comprising: a value chain comprising a set of interconnected assets; and a computing device comprising a processor and a memory, wherein the memory comprises instructions stored thereon that, when executed by the processor, cause the processor to perform operations comprising: generating a digital representation of the value chain comprising the set of interconnected assets; processing an alert associated with the set of interconnected assets; determining, based on processing the alert: a risk associated with the value chain; and a root cause associated with the risk, wherein the root cause is associated with a first asset comprised in the set of interconnected assets; and providing a warning signal to a second asset comprised in the set of interconnected assets, wherein the second asset is upstream or downstream of the first asset.

Embodiment 10. The system as in any prior embodiment, wherein the instructions, when executed by the processor, further cause the processor to perform operations comprising: providing a recommendation comprising a corrective action associated with the root cause and the first asset.

Embodiment 11. The system as in any prior embodiment, wherein the instructions, when executed by the processor, further cause the processor to perform operations comprising: processing a second alert associated with the set of interconnected assets, wherein the alert and the second alert are respectively associated with different assets comprised in the set of interconnected assets, wherein determining the risk and the root cause is further based on processing the second alert.

Embodiment 12. The system as in any prior embodiment, wherein the instructions, when executed by the processor, further cause the processor to perform operations comprising: processing sensor data associated with an asset comprised in the set of interconnected assets, wherein determining the risk and the root cause is further based on processing the sensor data.

Embodiment 13. The system as in any prior embodiment, wherein the instructions, when executed by the processor, further cause the processor to perform operations comprising: processing metrics associated with transporting a product associated with the value chain between different assets comprised in the set of interconnected assets, wherein determining the risk and the root cause is further based on processing the metrics.

Embodiment 14. The system as in any prior embodiment, wherein the value chain comprises a carbon capture, utilization, and sequestration (CCUS) value chain.

Embodiment 15. The system as in any prior embodiment, wherein the instructions, when executed by the processor, further cause the processor to perform operations comprising: generating the digital representation using physics-based modeling of the value chain and the set of interconnected assets, wherein the digital representation is a digital twin of the value chain and the set of interconnected assets.

Embodiment 16. The system as in any prior embodiment, wherein generating the digital representation, processing the alert, determining the risk and the root cause, and providing the warning signal are in real-time.

Embodiment 17. A computer program product comprising a computer readable storage medium having program instructions embodied therewith, the program instructions executable by a processor to cause the processor to perform operations comprising: generating a digital representation of a value chain comprising a set of interconnected assets; processing an alert associated with the set of interconnected assets; determining, based on processing the alert: a risk associated with the value chain; and a root cause associated with the risk, wherein the root cause is associated with a first asset comprised in the set of interconnected assets; and providing a warning signal to a second asset comprised in the set of interconnected assets, wherein the second asset is upstream or downstream of the first asset.

Embodiment 18. The computer program product as in any prior embodiment, wherein the instructions, when executed by the processor, further cause the processor to perform operations comprising: providing a recommendation comprising a corrective action associated with the root cause and the first asset.

Embodiment 19. The computer program product as in any prior embodiment, wherein the instructions, when executed by the processor, further cause the processor to perform operations comprising: processing a second alert associated with the set of interconnected assets, wherein the alert and the second alert are respectively associated with different assets comprised in the set of interconnected assets, wherein determining the risk and the root cause is further based on processing the second alert.

Embodiment 20. The computer program product as in any prior embodiment, wherein the instructions, when executed by the processor, further cause the processor to perform operations comprising: processing sensor data associated with an asset comprised in the set of interconnected assets, wherein determining the risk and the root cause is further based on processing the sensor data.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A computer-implemented method comprising:
generating, by a computing device, a digital representation of a value chain comprising a set of interconnected assets;
processing, by the computing device, an alert associated with the set of interconnected assets;
determining, based on processing the alert:
a risk associated with the value chain; and
a root cause associated with the risk, wherein the root cause is associated with a first asset comprised in the set of interconnected assets; and
providing a warning signal to a second asset comprised in the set of interconnected assets, wherein the second asset is upstream or downstream of the first asset.

2. The computer-implemented method of claim 1, further comprising:
providing, by the computing device, a recommendation comprising a corrective action associated with the root cause and the first asset.

3. The computer-implemented method of claim 1, further comprising:
processing, by the computing device, a second alert associated with the set of interconnected assets, wherein the alert and the second alert are respectively associated with different assets comprised in the set of interconnected assets,
wherein determining the risk and the root cause is further based on processing the second alert.

4. The computer-implemented method of claim 1, further comprising:
processing, by the computing device, sensor data associated with an asset comprised in the set of interconnected assets,
wherein determining the risk and the root cause is further based on processing the sensor data.

5. The computer-implemented method of claim 1, further comprising:
processing, by the computing device, metrics associated with transporting a product associated with the value chain between different assets comprised in the set of interconnected assets,
wherein determining the risk and the root cause is further based on processing the metrics.

6. The computer-implemented method of claim 1, wherein the value chain comprises a carbon capture, utilization, and sequestration (CCUS) value chain.

7. The computer-implemented method of claim 1, further comprising:
generating the digital representation using physics-based modeling of the value chain and the set of interconnected assets, wherein the digital representation is a digital twin of the value chain and the set of interconnected assets.

8. The computer-implemented method of claim 1, wherein generating the digital representation, processing the alert, determining the risk and the root cause, and providing the warning signal are in real-time.

2. A system comprising:
a value chain comprising a set of interconnected assets; and
a computing device comprising a processor and a memory, wherein the memory comprises instructions stored thereon that, when executed by the processor, cause the processor to perform operations comprising:
generating a digital representation of the value chain comprising the set of interconnected assets;
processing an alert associated with the set of interconnected assets;
determining, based on processing the alert:
a risk associated with the value chain; and
a root cause associated with the risk, wherein the root cause is associated with a first asset comprised in the set of interconnected assets; and
providing a warning signal to a second asset comprised in the set of interconnected assets, wherein the second asset is upstream or downstream of the first asset.

10. The system of claim 9, wherein the instructions, when executed by the processor, further cause the processor to perform operations comprising:
providing a recommendation comprising a corrective action associated with the root cause and the first asset.

11. The system of claim 9, wherein the instructions, when executed by the processor, further cause the processor to perform operations comprising:
processing a second alert associated with the set of interconnected assets, wherein the alert and the second alert are respectively associated with different assets comprised in the set of interconnected assets,
wherein determining the risk and the root cause is further based on processing the second alert.

12. The system of claim 9, wherein the instructions, when executed by the processor, further cause the processor to perform operations comprising:
processing sensor data associated with an asset comprised in the set of interconnected assets,
wherein determining the risk and the root cause is further based on processing the sensor data.

13. The system of claim 9, wherein the instructions, when executed by the processor, further cause the processor to perform operations comprising:
processing metrics associated with transporting a product associated with the value chain between different assets comprised in the set of interconnected assets,
wherein determining the risk and the root cause is further based on processing the metrics.

14. The system of claim 9, wherein the value chain comprises a carbon capture, utilization, and sequestration (CCUS) value chain.

15. The system of claim 9, wherein the instructions, when executed by the processor, further cause the processor to perform operations comprising:
generating the digital representation using physics-based modeling of the value chain and the set of interconnected assets, wherein the digital representation is a digital twin of the value chain and the set of interconnected assets.

16. The system of claim 9, wherein generating the digital representation, processing the alert, determining the risk and the root cause, and providing the warning signal are in real-time.

3. A computer program product comprising a computer readable storage medium having program instructions embodied therewith, the program instructions executable by a processor to cause the processor to perform operations comprising:
generating a digital representation of a value chain comprising a set of interconnected assets;
processing an alert associated with the set of interconnected assets;
determining, based on processing the alert:
a risk associated with the value chain; and
a root cause associated with the risk, wherein the root cause is associated with a first asset comprised in the set of interconnected assets; and
providing a warning signal to a second asset comprised in the set of interconnected assets, wherein the second asset is upstream or downstream of the first asset.

18. The computer program product of claim 17, wherein the program instructions, when executed by the processor, further cause the processor to perform operations comprising:
providing a recommendation comprising a corrective action associated with the root cause and the first asset.

19. The computer program product of claim 17, wherein the program instructions, when executed by the processor, further cause the processor to perform operations comprising:
processing a second alert associated with the set of interconnected assets, wherein the alert and the second alert are respectively associated with different assets comprised in the set of interconnected assets,
wherein determining the risk and the root cause is further based on processing the second alert.

20. The computer program product of claim 17, wherein the program instructions, when executed by the processor, further cause the processor to perform operations comprising:
processing sensor data associated with an asset comprised in the set of interconnected assets,
wherein determining the risk and the root cause is further based on processing the sensor data.
